(19) United States
(12) Patent Application Publication
(10) Pub. No.: US 2008/0007653 A1
(43) Pub. Date: Jan. 10, 2008

(54) Packet stream receiving apparatus

(75) Inventors: Hirofumi Mori, Koganei-shi (JP); Masataka Osada, Kawasaki-shi (JP); Tatsunori Saito, Sagamihara-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA

(21) Appl. No.: 11/796,950

(22) Filed: Apr. 30, 2007

(30) Foreign Application Priority Data
Jul. 7, 2006 (JP) 2006-188577

(51) Int. Cl. H04N 7/00

(52) U.S. Cl. 348/462; 348/E05.001

(57) ABSTRACT

The present invention provides a packet stream receiving apparatus, comprising a packet separation section that extracts a presentation time from a packet, a discontinuity detection section that detects a discontinuity of the packet, a storage buffer that stores decoded frames after the discontinuity has been detected, and a presentation time comparison section that calculates a number of lost frames based on the actual number of frames received from a discontinuity point in which the discontinuity was detected until the presentation time is obtained in the case where the storage buffer has stored the decoded frames. By accurately comprehending the number of lost frames caused by packet losses, outputs without timing mismatch are enabled.

### CROSS-REFERENCE TO RELATED APPLICATIONS

This application is based upon and claims the benefit of priority from prior Japanese Patent Application No. 2006-188577, filed Jul. 7, 2006, the entire contents of which are incorporated herein by reference.

### BACKGROUND OF THE INVENTION

1. Field of the Invention

The present invention relates to an apparatus for receiving a packet stream, and more particularly, to a packet stream receiving apparatus having a function of compensating error or errors in encoded audio data.

2. Description of the Related Art

Conventionally, in the digital terrestrial broadcasting of ISDT-T for mobile devices, the standard of MPEG-2AAC (Advanced-Audio-Coding) is employed as an audio encoding method, and an encoded stream is multiplexed to a packet of a transport stream (hereinafter, referred to as TS stream) for transmission. These days, there are various techniques for interpolating the lost frames caused by packet losses generated in the transmission process. For example, in JP-A 2000-307672 (KOKAI), there is disclosed a processing of concealing errors on the decoding side when packet losses have been generated (refer to paragraph [0026] and the like of this Patent Document).

However, in the audio encoding of MPEG-2AAC, there exists no information representing the frame numbers, and therefore, if any error is detected in decoding, there is a problem that the number of lost frames cannot be detected accurately. Further, a conventional decoder assumes that there is an environment in which errors are generated randomly in the TS stream, it determines that one frame is lost if any error is detected. However, if a plurality of frames is lost in the TS stream, there is a problem that the number of lost frames cannot be detected accurately.

Further, in JP-A 2000-307672 (KOKAI) does not disclose a technology of detecting which frame is lost due to packet losses, and thus, there is a problem that encoded audio data cannot be decoded accurately.

### BRIEF SUMMARY OF THE INVENTION

An object of the present invention is to output audio data without being out of synchronization of presentation timings by accurately detecting the number of lost frames caused by packet losses.

According to a first aspect of the present invention, there is provided an apparatus for receiving a packet stream, comprising:

a packet separation section configured to separate packets from the packet streams, each of the packets having a packet header and a payload, and extract a presentation time from the packet header;

a decoder configured to decode payloads to data frames;

a discontinuity detection section configured to detect a discontinuity of a sequence of the packets from the packet headers;

a storage buffer section configured to store peculiar data frame or frames between the detection of the discontinuity and the detection of the presentation time after the detection of the discontinuity; and

a calculating section configured to calculate a number of lost frames based on the actual number of the peculiar data frames stored in the storage buffer section.

According to a second aspect of the present invention, there is provided an apparatus for receiving a transport stream, comprising:

a packet separation section configured to separate the transport stream to PES packets, each PES packet having a packet header and a payload, the packet header including presentation time stamp and continuity index, and the packet separation section extracting the presentation time stamp from the PES packet header;

a discontinuity detection section configured to detect a discontinuity of a sequence of the packets based on the continuity indexes to output discontinuity information, the sequence of the packets including a preceding packet header and a following packet header;

a decoding section configured to decode the payloads to audio frames, and separate peculiar audio frame or frames between the detection of the discontinuity and the detection of the time stamp received in the following packet header, in response to the discontinuity information;

a storage buffer section configured to store the peculiar audio frames; and

a presentation time comparison section configured to calculating the actual number of peculiar audio frames, and calculate a total number of lost audio frames and the peculiar audio frames between the preceding packet header and the following packet header from a time interval between the presentation time stamps received in the preceding and following packet headers, respectively, so that the number of lost frames is calculated by subtracting the actual number of frames from the total number of frames.

According to a third aspect of the present invention, there is provided an apparatus for receiving a transport stream, comprising;

a packet separation section configured to separate the transport stream to PES packets, each of the PES packets having a packet header and a payload of encoded audio frames, the packet header including a presentation time stamp and continuity index, and the packet separation section extracting the presentation time stamp and encoded audio frames from the PES packet;

a discontinuity detection section configured to detect a discontinuity of a sequence of the packets based on the continuity indexes to output discontinuity information, the sequence of the packets including a preceding packet header and a following packet header a decoding section configured to decode the encoded audio frames to audio frames and separate peculiar audio frames or frames between the detection of the discontinuity and the detection of the time stamp received in the following packet header, in response to the discontinuity information;

a storage buffer section configured to store the peculiar audio frames;

a presentation time comparison section configured to calculating the actual number of peculiar audio frames, and calculate a total number of lost audio frames and the peculiar audio frames between the preceding packet header and the following packet header from a time interval between the presentation time stamps received in the preceding and following packet headers, respectively, so that the number of lost frames is calculated by subtracting the actual number of audio frames from the total number of frames;

a lost frame interpolation section configured to generate interpolation frames depending on the number of lost frames;

a presentation time calculation section configured to calculate a presentation time of the interpolation frame by adding frame time to the presentation time stamp in the preceding packet header, and also calculate a presentation time of the interpolation frame by adding frame time to the presentation time stamp in the packet header of the interpolation frame;

a presentation control section configured to control the audio frames so as to be outputted with being interpolated by the interpolation frames based on the presentation time; and

an outputting section configured to output the audio frames and the interpolation frames, based on the control of the presentation control section.

Additional objects and advantages of the invention will be set forth in the description which follows, and in part will be obvious from the description, or may be learned by practice of the invention. The objects and advantages of the invention may be realized and obtained by section of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing an apparatus for receiving a packet stream according to one embodiment of the present invention;

FIGS. 2A to 2E are conceptual views showing the detection process of packet losses in the apparatus shown in FIG. 1;

FIG. 3 is an illustrative view showing an apparatus according to a comparative example and frame outputs processed in the apparatus shown in FIG. 1;

FIG. 4 is a flowchart illustrating a series of processes in a packet separation section in the packet stream receiving apparatus according to one embodiment of the present invention;

FIG. 5 is a flowchart illustrating in detail a series of processes in an audio decoding section in the packet stream receiving apparatus shown in FIG. 1; and

FIG. 6 is a flowchart illustrating further in detail the stored frame processing shown in FIG. 5.

### DETAILED DESCRIPTION OF THE INVENTION

Now, an apparatus for receiving a TS (transport) packet stream according to the embodiment of the present invention will be described with reference to the accompanying drawings.

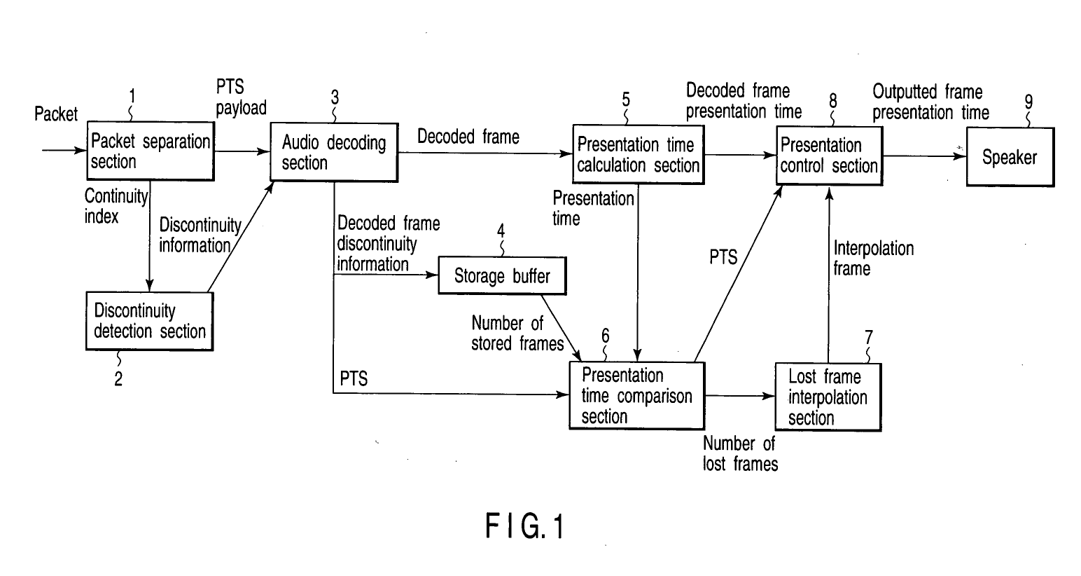

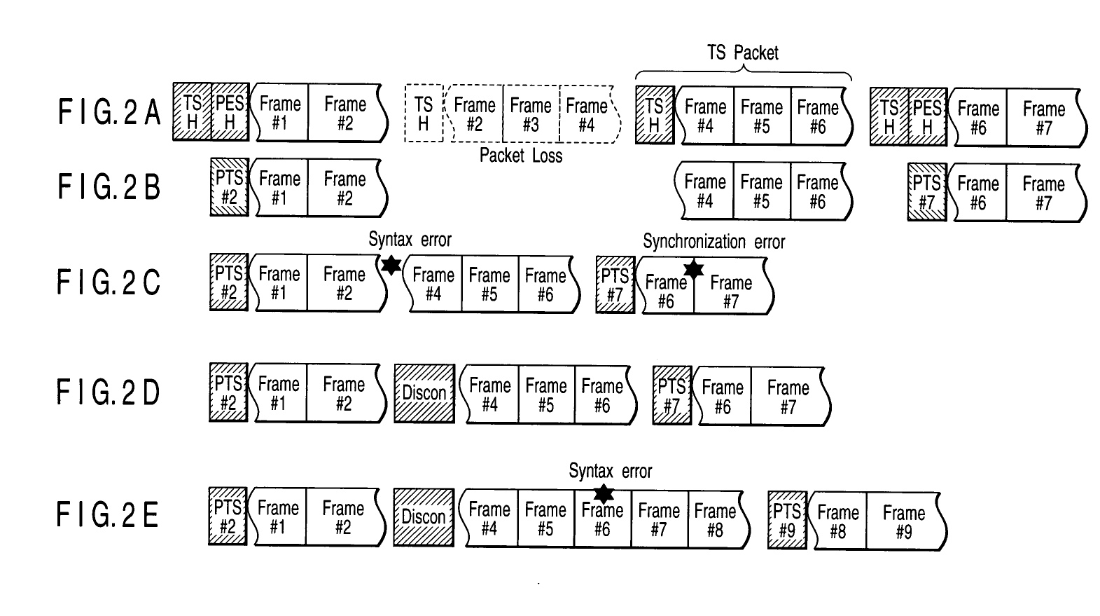

FIG. 1 is a block diagram showing an apparatus for receiving a packet stream according to one embodiment of the present invention. FIGS. 2A to 2E are views showing the detection process of packet losses in the apparatus shown in FIG. 1.

As shown in FIG. 1, the apparatus for receiving a packet stream includes a packet separation section 1, a discontinuity detection section 2, an audio decoding section 3, a storage buffer 4, a presentation time calculation section 5, a presentation time comparison section 6, a lost frame interpolation section 8, a presentation control section 8, and speakers 9.

The packet stream receiving apparatus has an input section (not shown) which receives a transport packet stream (hereinafter, referred to as TS stream) defined in MPEG-2 or the like, and the TS stream is transferred to the packet separation section 1.

Here, the TS stream is composed of a plurality of TS packets as shown in FIG. 2. Each of the TS packets is a fixed-length packet of 188 bytes and is composed of a TS packet header (denoted by TS H in FIG. 2A) and a TS packet payload. The TS packet payload corresponds to a segment of a packetized elementary stream (PES) and is packetized in the TS packet payload. Thus, the segment of the packetized elementary stream (PES) has the size of the TS packet payload and is stored in the TS packet payload. The packetized elementary stream (PES) is composed of a plurality of PES packets, and each of the PES packets is composed of a PES packet header (denoted by PES H in FIG. 2A) and a PES packet payload (corresponding to Frame #1, #2 . . . in FIGS. 2A and 2B). Further, the PES packet header includes a presentation time stamp (PTS) and the like. This PTS determines the presentation time of the video or audio contained in the payload in the relevant PES packet.

The packet separation section 1 extracts the TS packet header (PES H) from the TS packet and separates the packetized elementary stream (PES) shown in FIG. 2B. Here, the PTS is extracted from the PES packet header of the PES packet and the audio frame encoded from the PES packet payload is extracted.

Next, the discontinuity detection section 2 detects the discontinuity of the packet based on the continuity index in the TS packet header thus extracted, and when the discontinuity is detected, discontinuity information is transmitted to the audio decoding section 3 together with the PES packet payload. In this example, the discontinuity detection section 2 determines whether the discontinuity occurs or not based on a counter (Continuity Counter), but is not limited thereto.

The audio decoding section 3 decodes the PES packet payload to generate a decoded audio frame (hereinafter, referred to as “decoded frame”). Then, when the decoded frame is inputted from the audio decoding section 3, the presentation time calculation section 5 calculates the presentation time by adding the frame time to the previous presentation time. Then, the storage buffer 4 stores the decoded frames after the audio decoding section 3 has received the discontinuity information responding to the discontinuity information from the discontinuity detection section 2. Hereinafter, the number of decoded frames stored in the storage buffer is referred to as “stored frame number”. The presentation time comparison section 6 determines whether or not any lost frame exists to detect random errors by comparing the presentation time calculated in the presentation time calculation section 5 with the PTS obtained via the audio decoding section 3 because no discontinuity occurs if the stored frame number existing in the storage buffer 4 is “0”.

On the other hand, since packet losses have been occurred if more than one stored frames exist in the storage buffer 4, the presentation time comparison section 6 sets the presentation time of the current frame in the PTS and sets the presentation time in the previous frames by calculating back from the current PTS.

In this manner, if any lost frame exists, the lost frame interpolation section 7 generates interpolation frames depending on the number of lost frames notified by the presentation time comparison section 6 to output the relevant interpolation frames to the presentation control section 8. Then, the presentation control section 8 outputs audio from the speakers 9 while appropriately interpolating the lost frames with interpolation frames transmitted from the lost frame interpolation section 7 based on the presentation time and the decoded frames transmitted from the presentation time calculation section 5.

FIG. 2C is a view showing a processing in an apparatus according to a comparative example. As shown in FIG. 2C, if any syntax error is detected, the TS headers are detected and the length between the TS headers are confirmed. In the comparative example, for the decoded frames, three frames (frames #2, #3 and #4) are lost among Frames #1 to #5. However, since the number of lost frames cannot be recognized, the processing is performed as only one frame is lost. Therefore, although five frames should exist between PTS #2 and PTS #7 in a normal stream, only three frames have been processed due to packet losses, resulting in out-of-synchronization. That is, a synchronization errors is occurred, requiring re-synchronization.

In contrast thereto, in the packet stream receiving apparatus according to the present embodiment, as shown in FIG. 2D, if the discontinuity detection section 2 detects any packet loss based on the continuity index transmitted from the packet separation section 1, discontinuity information is inserted to specify a discontinuity point (Discon) in the separation stream. When the inserted discontinuity information is detected, the presentation time comparison section 6 calculates the number of frames existing between the PTSs from the PTS interval. Thereby, the number of lost frames caused by the discontinuity can be comprehended accurately. Further, the number of frames received from the discontinuity point to the frame having the PTS is searched, and the number of lost frames caused by packet losses is obtained from the detected frame number and the PTS interval.

In addition, the errors occurred in a zone where no discontinuity information exists are presumed to be random errors. Thus, as shown in FIG. 2E, these errors can be handled by switching the error resistance processing between packet losses and random errors. That is, in this case, if any Syntax error is detected in the transmission process, the error is not a discontinuity point, thereby determining that the lost frame caused by the error is only one frame.

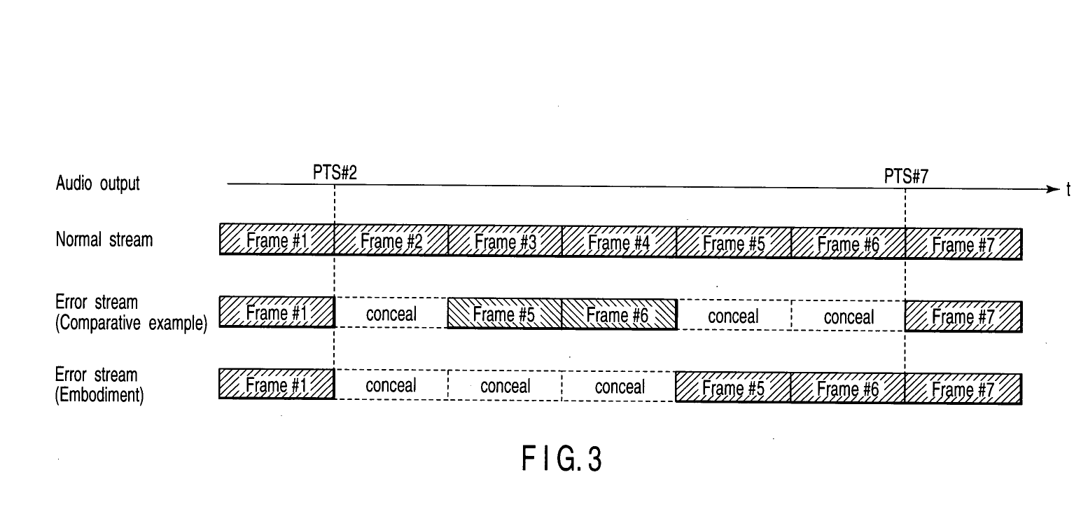

As a result of the above processing, the audio output shown in FIG. 3 is outputted. In a normal packet stream, frames #1 to #7 are continuously outputted. As shown as the comparative example, generation of any packet loss would result in out-of-synchronization in contrast to the audio output in the normal packet stream, requiring re-synchronization. In the packet stream receiving apparatus according to the embodiment, the number of lost frames caused by packet losses can be obtained from the number of detected frames and the PTS interval, thus no re-synchronization is required and timing mismatch can be prevented.

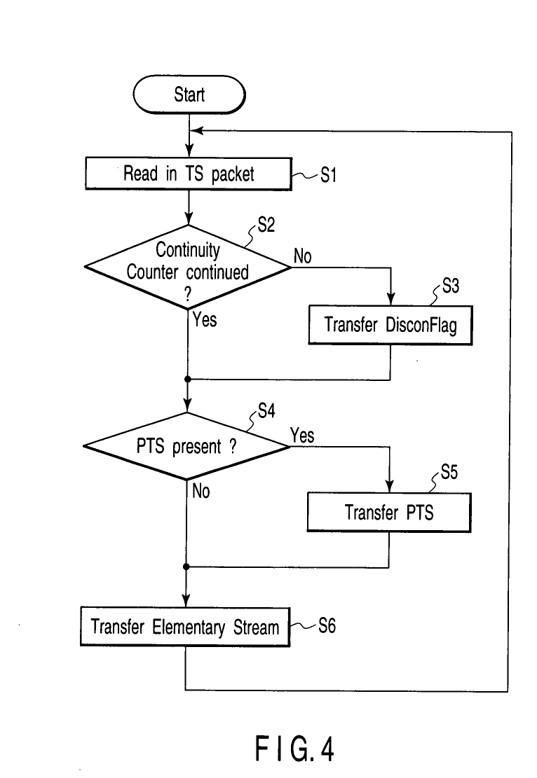

Now, a series of processes performed by the packet separation section 1 in the packet stream receiving apparatus according to one embodiment of the present invention will be described further in detail with reference to the flowchart of FIG. 4.

The packet separation section 1 reads a TS packet (Step S1) and judges whether or not any discontinuity occurs based on a counter (Continuity Counter) as a continuity index contained in the TS packet header of the relevant TS packet (Step S2). When determined that no discontinuity occurs, the procedure proceeds to Step 4. On the other hand, when determined in Step 2 that some discontinuity has occurred, discontinuity information (in this example, flag information DisconFlag) is transferred to the audio decoding section 3 and the procedure proceeds to Step S4 (Step 3).

Subsequently, the packet separation section 1 determines whether or not a PTS is contained in the PES packet header of the PES packet multiplexed on the TS packet (Step S4). When the relevant PTS is not contained, the procedure proceeds to Step S6. On the other hand, when the relevant PTS is contained in Step S4, the PTS is transferred to the audio decoding section 3 and the procedure proceeds to Step S6 (Step S5). In this manner, the packet separation section 1 transfers the encoded audio frames Frame #1, #2 . . . of the PES packet payload of the TS packet to the audio decoding section 3 (Step S6), returns to Step 1 and repeats the processing for each TS packet of the TS packet stream.

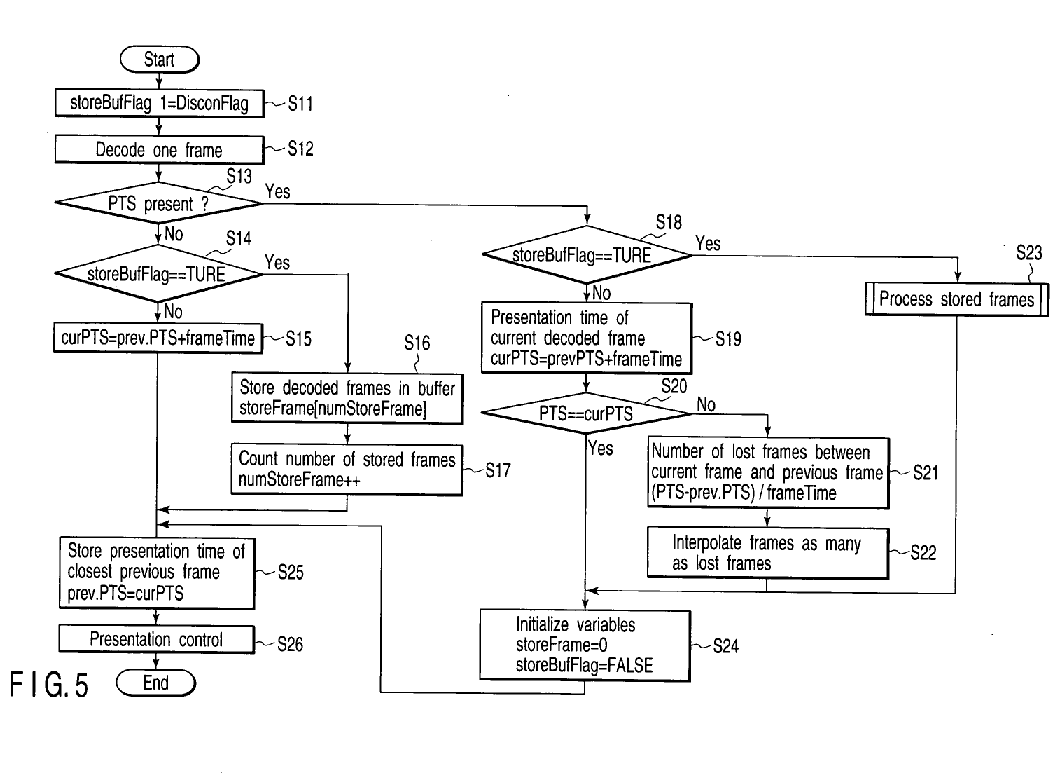

Now, a series of processes performed by the audio decoding section 3 in the packet stream receiving apparatus according to one embodiment of the present invention will be described further in detail with reference to the flowchart of FIG. 5.

When receiving discontinuity information (in this example, flag information DisconFlag), the audio decoding section 3 stores the relevant discontinuity information. In this example, the flag information DisconFlag is stored in storeBufFlag (Step S11), and only one frame of the encoded audio frames is decoded (Step S12). Subsequently, it is determined whether or not the presentation time (PTS) has been obtained (Step S13).

When it is determined in Step S13 that the PTS has not been obtained, it is determined whether or not the discontinuity information is stored (Step S14). In this example, the authenticity of DisconFlag stored in storeBufFlag is determined. When no discontinuity information is stored in Step S14, the frame time length (frameTime) is added to the presentation time previous to the discontinuity (prev.PTS) so that the current presentation time (curPTS) is calculated (Step S15), and the procedure proceeds to Step S25. On the other hand, when discontinuity information is stored in Step S14, decoded frames are stored in the storage buffer 4 (Step S16), and the count concerning the stored frame number is incremented (numStoreFrame++) (Step S17) and the procedure proceeds to Step S25.

On the other hand, when it is determined in Step S13 that the presentation time (PTS) has been obtained, it is then determined whether or not the discontinuity information is stored (Step S18). Similarly as in the above case, the authenticity of DisconFlag stored in storeBufFlag is determined.

When no discontinuity information is stored in Step S18, the presentation time of the current decoded frame is calculated (Step S19). This current presentation time (curPTS) is obtained by adding the frame time length (frameTime) to the presentation time previous to the discontinuity (prev.PTS) (Step S15).

Then, it is determined whether or not the presentation time (PTS) obtained in Step 13 is equal to the current presentation time (curPTS) calculated in Step 19 (Step S20). When both presentation times are determined to be equal to each other, various variables are initialized. In this example, the stored frame number storeframe of the storage buffer 4 is set to 0, and storeBufFlag concerning the discontinuity information is set to FALSE (Step S24) and the procedure proceeds to Step 25. On the other hand, when both presentation times are determined not to be equal to each other, it is assumed that random errors have occurred, the number of lost frames between the current frame and previous frame is calculated ((PTS-prev.PTS)/frameTime) (Step S21), frames as many as the lost frames are interpolated in the lost frame interpolation section 7 (Step S22), and various variables are initialized. In this example, the stored frame number storeframe is set to 0, and storeBufFlag concerning the discontinuity information is set to FALSE (Step S24). On the other hand, it is judged in Step S18 that the discontinuity information is stored, a subroutine “Stored frame processing” described later in detail is executed (Step S23), and various variables are initialized. In this example, the stored frame number storeframe of the storage buffer is set to 0, and storeBufFlag concerning the discontinuity information is set to FALSE (Step S24).

In this manner, the presentation time of the closest previous frame is stored in Step S25. In this example, Prev.PTS=curPTS (Step S25) is set, the presentation control is performed by the presentation control section 8 (Step S26), and a series of processings is ended.

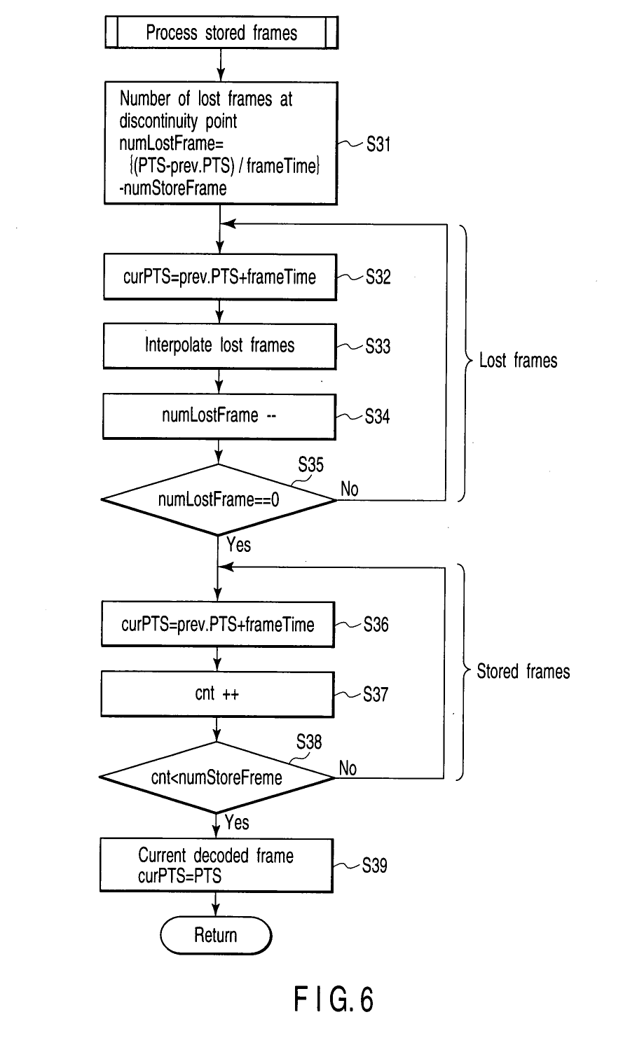

Now, the stored frame processing according to the subroutine executed in Step S23 of FIG. 5 will be described further in detail with reference to the flowchart of FIG. 6.

When entering the stored frame processing, the number of lost frames (numLostFrame) at the discontinuity point is calculated first (Step S31). Since the number of the frames from the current time to the discontinuity occurrence time is obtained by dividing a time period (=current presentation time (PTS) - presentation time previous to discontinuity (prev.PTS)) by the frame time length (frameTime), the number of frames from the current time to the discontinuity occurrence time can be obtained by subtracting the number of frames stored in the storage buffer 4 from the number of frames from the current time to the discontinuity occurrence time.

For example, in the example of FIG. 2B, the variables are as follows:

Presentation time before discontinuity:
prev.PTS→Frame1

Current presentation time:
PTS→Frame7

Number of frames in storage buffer:
numStoreFrame=2(Frame5, 6)

Number of lost frames at discontinuity point:
numLostFrame=3

Then, the lost frame interpolation section 7 interpolates lost frames (Steps S32 to S35). That is, the current presentation time (curPTS) is calculated from the sum of the presentation time previous to discontinuity (prev.PTS) and the frame time length (frameTime) (Step S32), the lost frames are interpolated (Step S33), and the number of lost frames at the discontinuity point is decremented by one (Step S34). The above processes are repeated until numLostFrame becomes equal to 0 (Step S35). Through the processes described above all lost frames are interpolated.

Next, time information is added to the stored frames stored in the storage buffer 4 (Steps S36 to S38). That is, the current presentation time (curPTS) is calculated from the sum of the presentation time previous to discontinuity (prev.PTS) and the frame time length (frameTime) (Step S32). Until the value of the relevant counter becomes equal to the number of stored frames, the addition of the time information to the stored frames is repeated (Steps S37 and S38). After the above processes, the current decoded frame (curPTS=PTS) is identified (Step S39), and the procedure is returned to the processes after Step S23 of FIG. 5.

In addition, for the timing for resetting the frames stored in the storage buffer 4, various methods can be employed such as a control method using time information and a control method using data amount.

As described above, according to the embodiment of the present invention, there is provided a packet stream receiving apparatus capable of outputting audio without generating a timing mismatch by inserting discontinuity information at the timing when the discontinuity occurs to accurately comprehend the number of lost frames from the relevant discontinuity information, and PTS interval and so forth.

According to the present invention, there can be provided a packet stream receiving apparatus having an audio error compensation function that enables outputs without generating a timing mismatch by accurately comprehending the number of lost frames caused by packet losses.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for receiving a packet stream, comprising:
a packet separation section configured to separate packets from the packet streams, each of the packets having a packet header and a payload, and extract a presentation time from the packet header;
a decoder configured to decode payloads to data frames;
a discontinuity detection section configured to detect a discontinuity of a sequence of the packets from the packet headers;
a storage buffer section configured to store peculiar data frame or frames between the detection of the discontinuity and the detection of the presentation time after the detection of the discontinuity; and
a calculating section configured to calculate a number of lost frames based on the actual number of the peculiar data frames stored in the storage buffer section.

2. An apparatus for receiving a transport stream, comprising:
a packet separation section configured to separate the transport stream to PES packets, each PES packet having a packet header and a payload, the packet header including presentation time stamp and continuity index, and the packet separation section extracting the presentation time stamp from the PES packet header;
a discontinuity detection section configured to detect a discontinuity of a sequence of the packets based on the continuity indexes to output discontinuity information, the sequence of the packets including a preceding packet header and a following packet header;
a decoding section configured to decode the payloads to audio frames, and separate peculiar audio frame or frames between the detection of the discontinuity and the detection of the time stamp received in the following packet header, in response to the discontinuity information;
a storage buffer section configured to store the peculiar audio frames; and
a presentation time comparison section configured to calculate the actual number of peculiar audio frames, and calculate a total number of lost audio frames and the peculiar audio frames between the preceding packet header and the following packet header from a time interval between the presentation time stamps received in the preceding and following packet headers, respectively, so that the number of lost frames is calculated by subtracting the actual number of frames from the total number of frames.

3. The apparatus according to claim 2, wherein the presentation time comparison section calculates the total number of the lost and peculiar audio frames by dividing the time interval by the frame time length.

4. The apparatus according to claim 3, wherein the presentation time comparison section calculates the actual number of the peculiar audio frames by dividing the difference between a discontinuity point identified by the discontinuity information and the presentation time stamp received in the following packet header by the frame time length.

5. The packet stream receiving apparatus according to claim 2, wherein, if any error occurs between the preceding packet header and the following packet header, the processing is performed assuming that the number of lost frames caused by errors is one.

6. An apparatus for receiving a transport stream, comprising;
a packet separation section configured to separate the transport stream to PES packets, each of the PES packets having a packet header and a payload of encoded audio frames, the packet header including a presentation time stamp and continuity index, and the packet separation section extracting the presentation time stamp and encoded audio frames from the PES packet;
a discontinuity detection section configured to detect a discontinuity of a sequence of the packets based on the continuity indexes to output discontinuity information, the sequence of the packets including a preceding packet header and a following packet header
a decoding section configured to decode the encoded audio frames to audio frames and separate peculiar audio frames or frames between the detection of the discontinuity and the detection of the time stamp received in the following packet header, in response to the discontinuity information;
a storage buffer section configured to store the peculiar audio frames;
a presentation time comparison section configured to calculate the actual number of peculiar audio frames, and calculate a total number of lost audio frames and the peculiar audio frames between the preceding packet header and the following packet header from a time interval between the presentation time stamps received in the preceding and following packet headers, respectively, so that the number of lost frames is calculated by subtracting the actual number of audio frames from the total number of frames;
a lost frame interpolation section configured to generate interpolation frames depending on the number of lost frames;
a presentation time calculation section configured to calculate a presentation time of the interpolation frame by adding frame time to the presentation time stamp in the preceding packet header, and also calculate a presentation time of the interpolation frame by adding frame time to the presentation time stamp in the packet header of the interpolation frame;
a presentation control section configured to control the audio frames so as to be outputted with being interpolated by the interpolation frames based on the presentation time; and
an outputting section configured to output the audio frames and the interpolation frames, based on the control of the presentation control section.

7. The apparatus according to claim 6, wherein the presentation time comparison section calculates the total number of the lost and peculiar audio frames by dividing the time interval by the frame time length.

8. The apparatus according to claim 7, wherein the presentation time comparison section calculates the actual number of the peculiar audio frames by dividing the difference between a discontinuity point identified by the discontinuity information and the presentation time stamp received in the following packet header by the frame time length.

9. The packet stream receiving apparatus according to claim 7, wherein, if any error occurs between the preceding packet header and the following packet header, the processing is performed assuming that the number of lost frames caused by errors is one.
